(19) United States
(12) Patent Application Publication
(10) Pub. No.: US 2026/0300942 A1
(43) Pub. Date: Oct. 1, 2026

(54) INFLUENCER SCORING SYSTEM BASED UPON REPUTATIONAL DATA AND RELATED METHODS

(71) Applicant: Inmar Brand Solutions, Inc., Winston-Salem, NC (US)

(72) Inventors: Jeffery Hayes, Seattle, WA (US); Sharon Williams, Greensburg, KY (US); Gustavo Dellacroce, Chicago, IL (US); Samuel Edeh, Lawrenceville, GA (US); Christopher J. Henry, Chicago, IL (US); Kathryn Rouse, Winston-Salem, NC (US)

(21) Appl. No.: 19/564,101

(22) Filed: Mar. 11, 2026

Related U.S. Application Data
(60) Provisional application No. 63/777,622, filed on Mar. 25, 2025.

(51) Int. Cl. G06Q 10/46

(52) U.S. Cl. CPC G06Q 10/46

(57) ABSTRACT

An influencer scoring system may include a user device and an influencer scoring server. The influencer scoring server may be configured to obtain, from a user device, a unique identifier associated with a social media influencer to be considered for content generation for a given brand. The unique identifier may be used by the social media influencer on a social media platform, for example. The server may be configured to determine an identity of the given social media influencer based upon the unique identifier and search data sources external to the social media platform to obtain reputational data associated with the social media influencer based upon the identity of the social media influencer. The server may be configured to generate a reputational risk score associated with the social media influencer based upon the reputational data and communicate the reputational risk score to the user device for display thereat.

### RELATED APPLICATIONS

The present application claims the priority benefit of provisional application Ser. No. 63/777,622 filed on Mar. 25, 2025, the entire contents of which are herein incorporated by reference.

### TECHNICAL FIELD

The present invention relates to the field of digital promotion processing, and, more particularly, to generating a digital promotion for matched influencer-shoppers, and related methods.

### BACKGROUND

Sales of a particular product or service may be based upon how well that product or service is marketed to a consumer. One form of marketing is called influencer marketing. Influencer marketing enables a brand, for example, to connect with potential customers. In many instances, a consumer may trust an influencer over other types of content, for example, brand content. An influencer may address the shortcomings of brand content or a typical marketing campaign by using the influencer's media reach to educate consumers on the given product and/or provide positive feedback about the given product.

An influencer, for example, may generate content for more than one brand. An influencer may also provide feedback in the form of a review that may not be helpful to a particular brand or marketing campaign. Even still further, an influencer may have previously provided content about a sensitive topic (e.g., political, financial) unrelated to brand content or a marketing campaign.

Another form of marketing or promotion is a coupon, typically in paper form, for a discount toward the product or service. Some coupons may be retailer specific, for example, only redeemable for the discount at a particular retailer, while other coupons may be product specific from a manufacturer and redeemable at any retailer.

### SUMMARY

An influencer scoring system may include a user device and an influencer scoring server. The influencer scoring server may be configured to obtain, from the user device, a unique identifier associated with a given social media influencer to be considered for content generation for a given brand. The unique identifier may be used by the given social media influencer on a social media platform. The influencer scoring server may be configured to determine an identity of the given social media influencer based upon the unique identifier.

The influencer scoring server may be configured to search a plurality of data sources external to the social media platform to obtain reputational data associated with the given social media influencer based upon the identity of the given social media influencer. The influencer scoring server may be configured to generate a reputational risk score associated with the given social media influencer based upon the reputational data. The influencer scoring server may be configured to communicate the reputational risk score to the user device for display thereat.

The influencer scoring server may be configured to obtain the reputational data based upon the identity of the given social media influencer being mentioned in the reputational data, for example. The reputational data may include at least one of documented actions and documented expressions of the given social media influencer.

The influencer scoring server may be configured to discard duplicate reputational data, for example. The reputational data may include at least one event associated with the given social media influencer, and the influencer scoring server may be configured to determine whether the given social media influencer is a direct actor of the at least one event and, if not, discard the reputational data associated with the at least one event.

The identity may include a first name and a last name associated with the given social media influencer, for example. The influencer scoring server may be configured to generate the reputational risk score further based upon historical social media content from the social media platform.

The influencer scoring server may be configured to discard reputational data based upon an age of the reputational data, for example. The influencer scoring server may be configured to operate a large language model (LLM) to generate the reputational risk score.

The influencer scoring server may be configured to operate an LLM to determine the identity of the given social media influencer based upon the unique identifier, for example. The influencer scoring server may be configured to generate the reputational risk score for reputational data indicative of at least one of a crime committed by the given social media influencer, aggression shown by the given social media influencer, misconduct shown by the given social media influencer, and positions of the given social media influencer on controversial topics, for example. The reputational data may include news articles, public records databases, online comments, photographs, and videos, for example.

A method aspect is directed to a method of scoring an influencer. The method may include using an influencer scoring server to obtain, from a user device, a unique identifier associated with a given social media influencer to be considered for content generation for a given brand. The unique identifier may be used by the given social media influencer on a social media platform. The method may include using the influencer scoring server to determine an identity of the given social media influencer based upon the unique identifier and search a plurality of data sources external to the social media platform to obtain reputational data associated with the given social media influencer based upon the identity of the given social media influencer. The method may also include using the influencer scoring server to generate a reputational risk score associated with the social media influencer based upon the reputational data and communicate the reputational risk score to the user device for display thereat.

A computer readable medium aspect is directed to a non-transitory computer readable medium for scoring an influencer. The non-transitory computer readable medium includes computer executable instructions that when executed by a processor cause the processor to perform operations. The operations may include obtaining, from a user device, a unique identifier associated with a given social media influencer to be considered for content generation for a given brand. The unique identifier may be used by the given social media influencer on a social media platform.

The operations may include determining an identity of the given social media influencer based upon the unique identifier and searching a plurality of data sources external to the social media platform to obtain reputational data associated with the given social media influencer based upon the identity of the given social media influencer. The operations may also include generating a reputational risk score associated with the social media influencer based upon the reputational data and communicating the reputational risk score to the user device for display thereat.

### BRIEF DESCRIPTION OF THE DRAWINGS

FIG. 1 is a schematic diagram of a digital promotion processing system in accordance with an embodiment.

FIG. 2 is a schematic operational diagram of the digital promotion processing server of FIG. 1.

FIG. 3 is another schematic operational diagram of the digital promotion processing server of FIG. 1.

FIG. 4 is a schematic block diagram of a digital promotion processing server of FIG. 1.

FIG. 5 is a flow chart illustrating operation of the digital promotion processing server of FIG. 1.

FIG. 6 is a diagram illustrating conceptual operation of the digital promotion processing system of FIG. 1.

FIG. 7 is a schematic diagram of a digital promotion processing server in accordance with another embodiment.

FIG. 8 is a schematic diagram of an influencer scoring system in accordance with an embodiment.

FIG. 9 is a schematic operational diagram of the influencer scoring system of FIG. 8.

FIG. 10 is a schematic block diagram of the influencer scoring server of FIG. 8.

FIG. 11 is a flow diagram of operations of the influencer scoring server of FIG. 8.

FIG. 12 is another flow diagram of operations of the influencer scoring server of FIG. 8.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

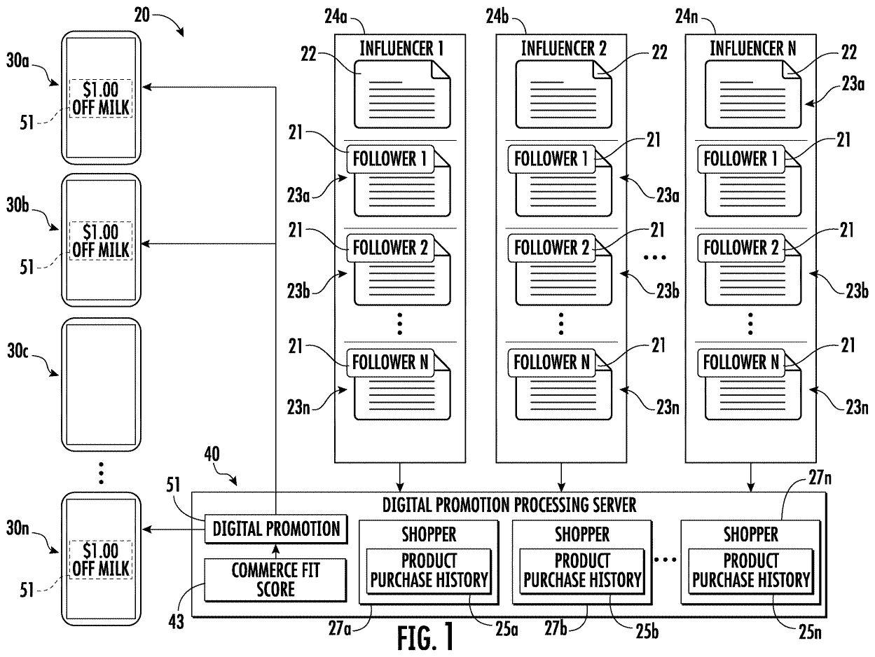

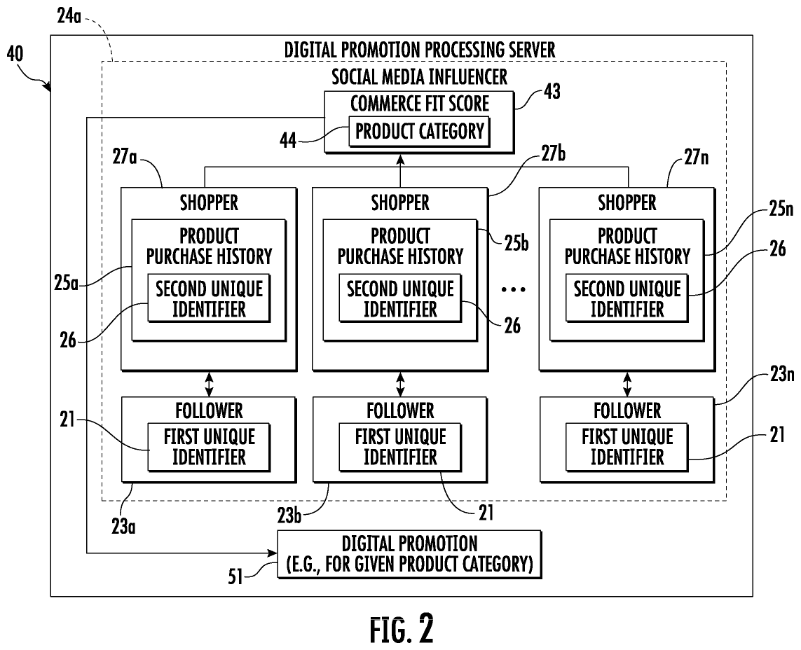

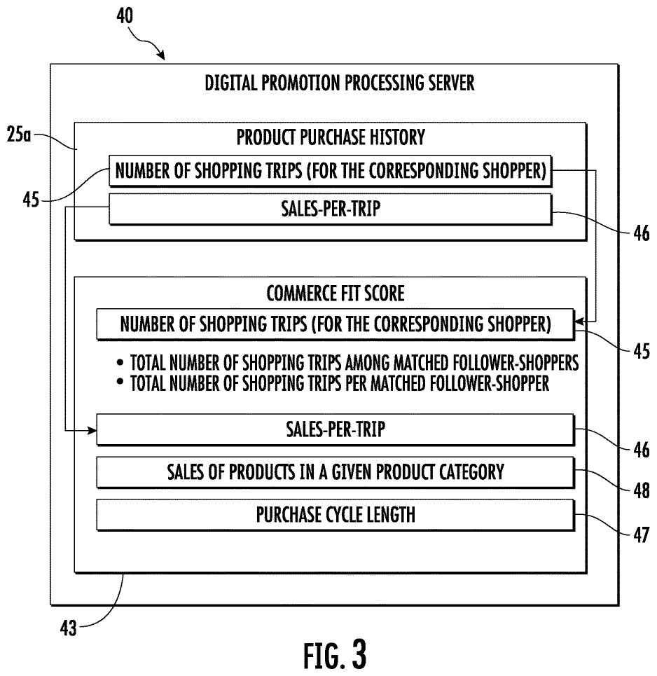

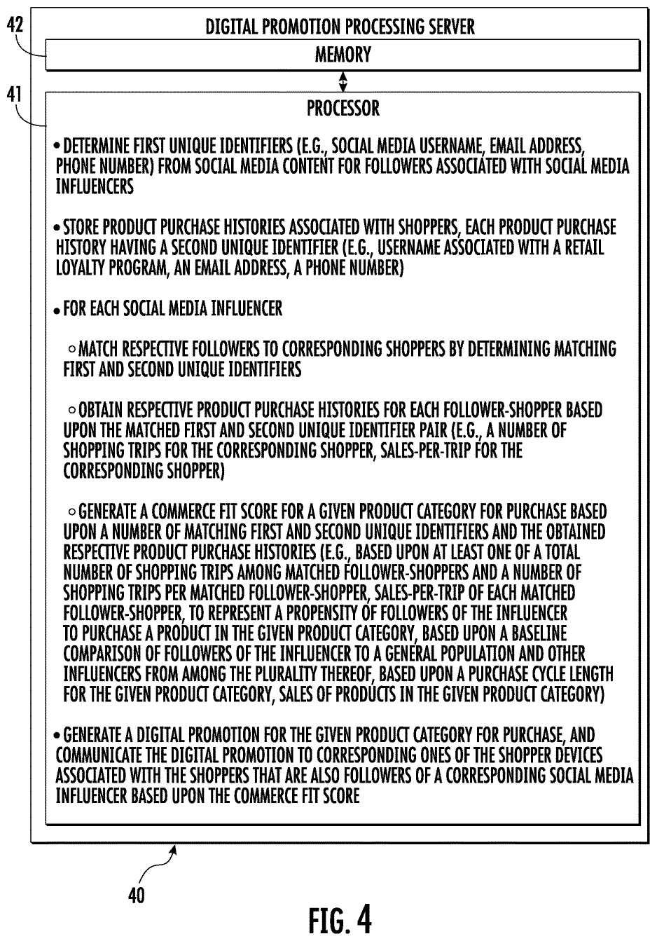

Referring initially to FIGS. 1-4, a digital promotion processing system 20 may include shopper devices 30a-30n. The shopper devices 30a-30n are each illustratively in the form of a mobile wireless communications device, particularly, a smartphone. However, each shopper devices 30a-30n may be in the form of another type of device, for example, tablet computer, laptop computer, personal computer, and wearable device.

The digital promotion processing system 20 also includes a digital promotion processing server 40. The digital promotion processing server 40 includes a processor 41 and an associated memory 42. While functions of the digital promotion processing server 40 are described herein, those skilled in the art will appreciate that the processor 41 and the memory 42 cooperate to perform these functions.

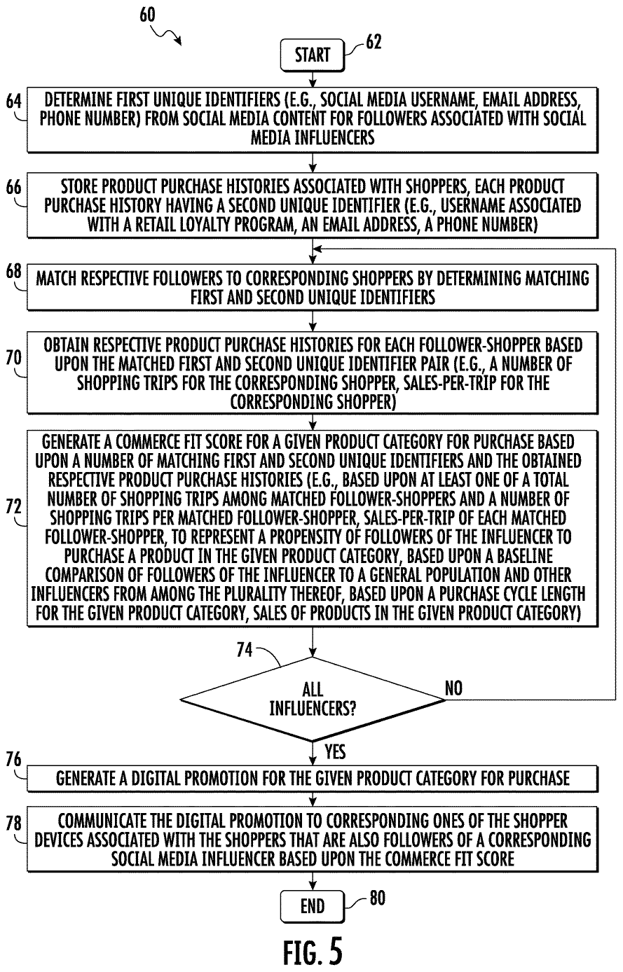

Referring now additionally to the flowchart 60 in FIG. 5, beginning at Block 62, operations of the digital promotion processing server 40 will now be described. At Block 64, the digital promotion processing server 40 determines first unique identifiers 21 from social media content 22 for followers 23a-23n associated with social media influencers 24a-24n. More particularly, a given social media influencer 24a may post social media content 22 to a social media platform. The social media content may include any one or more of text, images, links, videos, etc. For example, in some embodiments, a given social media influencer may provide a review of a given product or promote a given product or brand of products through the social media content 22. Each social media influencer 24a-24n has a username or social media handle that is used by the social media influencer on the social media platform. Each social media influencer 24a-24n may use a different username or social media handle on different social media platforms.

As will be appreciated by those skilled in the art, the followers 23a-23n may include social media users that “like” a given social media influencer 24a-24n, “follow” a given social media influencer, and/or respond to the given social media influencer with content, images, videos, etc. Each follower 23a-23n has a username or social media handle that is used by the follower on the social media platform.

The first unique identifier 21 may include one or more of a username, for example, social media username or handle, an email address, or a phone number. The first unique identifier 21 may include other and/or additional identifiers.

The digital promotion processing server 40, at Block 66, stores product purchase histories 25a-25n associated with shoppers 27a-27n. Each product purchase history 25a-25n, or shopper 27a-27n, has a second unique identifier 26 associated therewith. The second unique identifier 26 may include one or more of a username, for example, associated with a retailer or retail loyalty program, an email address, or a phone number. For example, a shopper's phone number may be associated with the shopper's loyalty program account and may be used to retrieve the shopper's product purchase history 25a-25n.

Each product purchase history 25a-25n may include a number of shopping trips 45 for the corresponding shopper. Each product purchase history 25a-25n may include a sales-per-trip 46 for the corresponding shopper. Each product purchase history 25a-25n may include quantities, descriptions, and prices paid for purchased products. Each product purchase history 25a-25n may also include times and dates of purchases, whether a promotion or coupon was applied, and/or retailer. Each product purchase history 25a-25n may include other and/or additional data regarding the shopper and the corresponding purchases. The product purchase histories 25a-25n may be obtained from point-of-sale (POS) devices at or associated with (e.g., online) one or more retailers. The product purchase histories 25a-25n may be updated as products are being purchased at the one or more retailers and communicated between the POS devices and the digital promotion processing server 40.

For each social media influencer 24a-24n, the digital promotion processing server 40 matches respective followers 23a-23n to corresponding shoppers 27a-27n by determining matching first and second unique identifier 21, 26 (Block 68). More particularly, the digital promotion processing server 40 may parse the social media content 22 associated with the corresponding social media influencer 24a-24n to determine the respective first unique shopper identifiers 21. The digital promotion processing server 40 may apply a model, for example, a text recognition model, to recognize social media usernames, email addresses, etc. that may be associated with the followers 23a-23n. Each parsed or identified first unique shopper identifier 21 may be compared to the stored second unique identifiers 26 for a match. In some embodiments, the digital promotion processing server 40 may apply translation operations to determine equivalents between the first and second unique identifiers 21, 26. For example, abbreviations, spelling variances, same words across different languages, and number-to-spelling variations may be considered equivalents.

At Block 70, for each social media influencer 24a-24n, the digital promotion processing server 40 obtains respective product purchase histories 25a-25n for each follower-shopper based upon the matched first and second unique identifiers 21, 26. The digital promotion processing server 40, for each social media influencer 24a-24n, generates a commerce fit score 43 for a given product category 44 for purchase (Block 72). The product category 44 for purchase may include groups or classes (e.g., families) of products. Exemplary product categories may include produce, dairy, baby products, meat, etc. Of course, the given product category 44 may include other and/or additional product categories, which may be broader or narrower, for example, with respect to meat, beef, poultry, etc. The product category 44 may be a single product, for example, as determined by a unique product identifier, and/or a brand of products.

The commerce fit score 43 may represent a propensity (e.g., predicted) of followers of the corresponding social media influencer 24a-24n to purchase a product in the given product category 44. In other words, the commerce fit score 43 may represent the propensity of a social media influencer's audience to buy the specific product category. More specifically, the digital promotion processing server 40 may generate the commerce fit score 43 based upon a baseline comparison of followers 23a-23n of the social media influencer 24a-24n (i.e., the given social media influencer) to a general population and other influencers from among the social media influencers.

The digital promotion processing server 40 may determine the commerce fit score 43 based upon a total number of shopping trips 45 among the matched follower-shoppers and/or a number of shopping trips per matched follower-shopper. The digital promotion processing server 40 may alternatively or additionally determine the commerce fit score 43 based upon the sales-per-trip 46 of each matched follower-shopper. The digital promotion processing server 40 may also generate the commerce fit score 43 based upon a purchase cycle length 47 for the given product category 44 (i.e., how many days between purchases of products within the same product category). The digital promotion processing server 40 may also generate the commerce fit score 43 based upon a sales of products 48 in the given product category 44. Other and/or additional data may be used by the digital promotion processing server 40 to generate the commerce fit score 43, for example, product purchase histories 25a-25n.

At Block 74, the digital promotion processing server 40 determines whether the operations performed at Blocks 68-72 have been completed for each social media influencer 24a-24n (e.g., from among the plurality of social media influencers). If the operations have not been completed for each social media influencer 24a-24n, then operations resume at Block 68 for the next social media influencer. Otherwise, operations continue at Block 76.

At Block 76, the digital promotion processing server 40 generates a digital promotion 51 for the given product category 44 for purchase. The digital promotion 51 is illustratively in the form of a digital coupon redeemable toward purchase of a product in the given product category 44. At Block 78, the digital promotion processing server 40 communicates, for example, wirelessly, the digital promotion 51 to corresponding ones of the shopper devices 30a-30n associated with the shoppers that are also followers 23a-23n of a corresponding social media influencer 24a-24n based upon the commerce fit score 43. The digital promotion 51 is illustratively displayed on the display the corresponding shopper devices 30a-30n. The corresponding shopper may provide input the respective shopper device 30a-30n to save the digital promotion 51 to a digital wallet associated with the shopper, for example, via a corresponding retailer loyalty account and application. Operations end at Block 80.

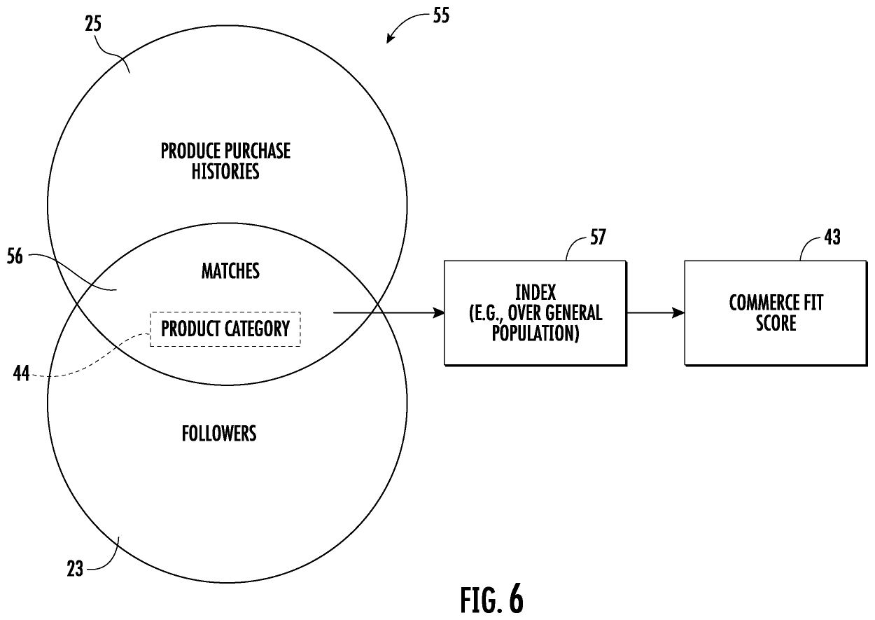

As will be appreciated by those skilled in the art, the digital promotion processing system 20 may be particularly advantageous for identifying a given social media influencer 24a-24n that may be considered a best fit for a marketing campaign or promotional campaign. More particularly, referring briefly to the diagram 55 in FIG. 6, the digital promotion processing system 20 may conceptually provide the matches 56 between product purchase histories 25 and followers 23 of a social media influencer. The matches 56 represent a retailer and product category 44 match that is used to generate an index 57 over the general population, which is thus used to generate the commerce fit score 43.

In a particular exemplary implementation, a given social media influencer 24a-24n may post social media content 22 relating to a particular brand of products for purchase or particular product for purchase. In the case of food, for example, the social media influencer 24a-24n may provide a written description of the food product and a review, along with images, locations, etc. Followers 23a-23n of the social media influencer 24a-24n typically will react to the social media content 22, for example, by posting content of their own or providing a reaction, for example, an emoji, emoticon, or other icon. Since these followers 23a-23n have a relationship to the social media influencer 24a-24n, the digital promotion processing system 20 may exploit this relationship by determining which of the followers are likely to purchase a product in the product category (e.g., food category) by matching the followers to a shopper 27a-27n (e.g., a retailer loyalty account of a shopper) and using the follower-shopper's transaction data (i.e., product purchase histories 25a-25n).

A manufacturer, retailer, or other issuer of a digital promotion may use this likelihood or propensity, in the form of a commerce fit score 43, to select a best one or best ones of the social media influencers 24a-24n for the digital promotion 51. In other words, a best fit social media influencer 24a-24n may be selected such that the selected social media influencer drives or has a highest number of shoppers 27a-27n purchasing in the product category in the social media influencer's audience (i.e., followers).

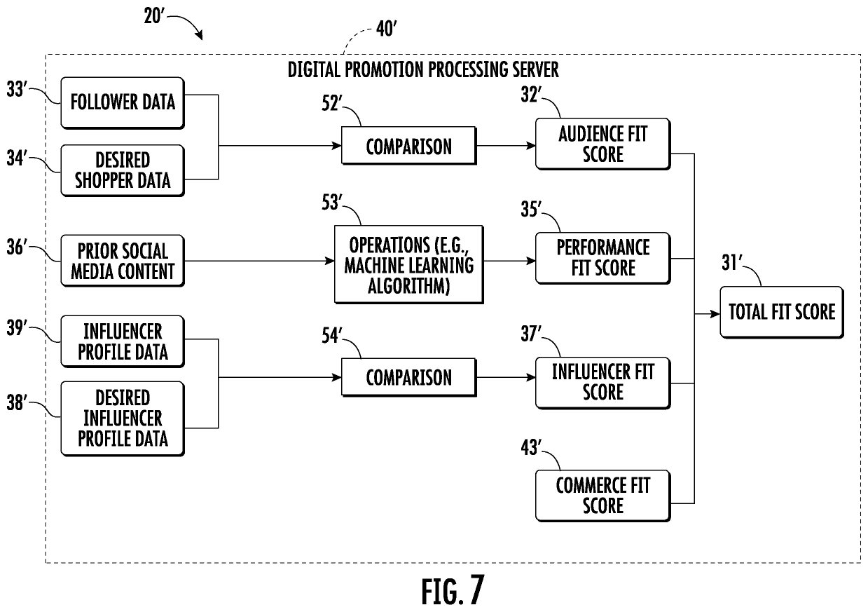

Referring now to FIG. 7, in another embodiment, the digital promotion processing system 20′ may use the commerce fit score 43′ to generate an overall or total fit score 31′. More particularly, the digital promotion processing server 40′ may generate an audience fit score 32′. The digital promotion processing server 40′ may obtain and store follower data 33′ associated with the followers of a given social media influencer. The follower data 33′ may conceptually be considered audience data and may include demographic data about those followers. Desired shopper data 34′ may also be obtained and stored by the digital promotion processing server 40′. The desired shopper data 34′ may be provided by a retailer, manufacturer, or otherwise associated with a digital promotion or promotional campaign and may represent the desired audience (e.g., in terms of demographics).

The digital promotion processing server 40′ may compare the desired shopper data 34′ and the follower data 33′ (comparison 52′) to generate the audience fit score 32′. The audience fit score 32′ may be generated similarly to the commerce fit score, described above, and/or via operation of a machine learning algorithm.

The digital promotion processing server 40′ may also generate a performance fit score 35′ based upon prior social media content 36′. The performance fit score 35′ may conceptually be considered a representation of how well the prior social media content 36′ was received by the followers and a measure of how those follows translate to shoppers, i.e., whether those followers become shoppers and purchase a product associated with the social media content. The digital promotion processing server 40′ may operate an algorithm or perform operations 53′, for example, based upon promotion redemption data and corresponding sales data to determine the performance fit score 35′.

The digital promotion processing server 40′ may also generate a creator or influencer fit score 37'. The influencer fit score 37′ is generated based upon desired influencer profile data 38′. Desired influencer profile data 38′ may include demographic and categorical data about the social media influencer, for example, gender, age, interests, etc. The digital promotion processing server 40′ compares the desired influencer profile data 38′ (comparison 54′) to influencer profile data 39′ associated with the social media influencer. Based upon matching, for example, a degree of matching, the digital promotion processing server 40′ may generate the influencer fit score 37′. The digital promotion processing server 40′ generates the total fit score 31′ based upon the audience fit score 32′, the performance fit score 35′, the influencer fit score 37′, and the commerce fit score 43′. The digital promotion processing server 40′ may generate the total fit score 31′ based upon weighting of the individual fit scores or other techniques, for example, operation of a machine learning algorithm that accepts the individual fit scores.

Actual performance and other data, as it becomes available and is obtained, may be used to train the machine learning algorithm as the overall data set becomes larger. Exemplary operations, for example, in terms of scoring, that may be performed by the digital promotion processing server 40′ are described in U.S. Pat. No. 11,042,896, the entire contents of which are herein incorporated by reference.

A method aspect is directed to a method of processing a digital promotion. The method includes using a digital promotion processing server 40 to determine a plurality of first unique identifiers 21 from social media content 22 for followers 23a-23n associated with a plurality of social media influencers 24a-24n, and store a plurality of product purchase histories 25a-25n associated with a plurality of shoppers 27a-27n. Each product purchase history 25a-25n has second unique identifier 26 associated therewith. The method also includes using the digital promotion processing server 40 to, for each social media influencer 24a-24n of the plurality thereof, match respective followers 23a-23n to corresponding shoppers 27a-27n by determining matching first and second unique identifiers 21, 26, obtain respective product purchase histories 25a-25n for each follower-shopper based upon the matched first and second unique identifier pair, and generate a commerce fit score 43 for a given product category 44 for purchase based upon a number of matching first and second unique identifiers and the obtained respective product purchase histories. The method further includes using the digital promotion processing server 40 to generate a digital promotion 51 for the given product category 44 for purchase, and communicate the digital promotion to corresponding ones of a plurality of shopper devices 30a-30n associated with the shoppers 27a-27n that are also followers 23a-23n of a corresponding social media influencer 24a-24n based upon the commerce fit score 43.

A computer readable medium aspect is directed to a non-transitory computer readable medium for processing a digital promotion. The non-transitory computer readable medium includes computer executable instructions that when executed by a processor 41 cause the processor to perform operations. The operations include determining a plurality of first unique identifiers 21 from social media content 22 for followers 23a-23n associated with a plurality of social media influencers 24a-24n, and storing a plurality of product purchase histories 25a-25n associated with a plurality of shoppers.

Each product purchase history 25a-25n has second unique identifier 26 associated therewith. The operations include, for each social media influencer 24a-24n of the plurality thereof, matching respective followers 23a-23n to corresponding shoppers 27a-27n by determining matching first and second unique identifiers 21, 26, obtaining respective product purchase histories 25a-25n for each follower-shopper based upon the matched first and second unique identifier pair, and generating a commerce fit score 43 for a given product category for purchase based upon a number of matching first and second unique identifiers and the obtained respective product purchase histories. The operations may also include generating a digital promotion 51 for the given product category 44 for purchase, and communicating the digital promotion to corresponding ones of a plurality of shopper devices 30a-30n associated with the shoppers 27a-27n that are also followers of a corresponding social media influencer 24a-24n based upon the commerce fit score 23.

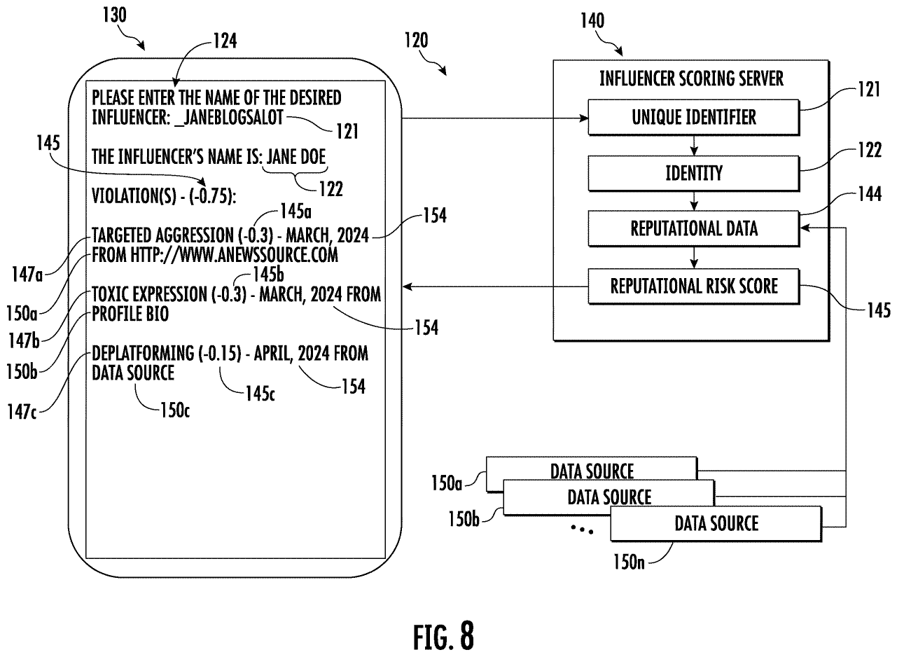

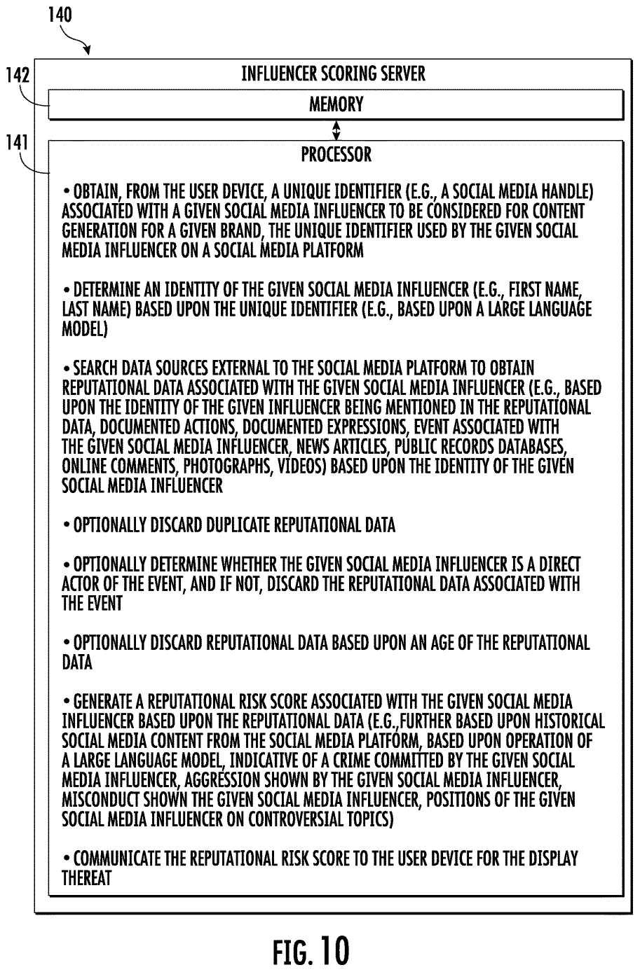

Referring now to FIGS. 8-10, another embodiment is directed to an influencer scoring system 120. The influencer scoring system 120 includes a user device 130. The user device 130 is illustratively in the form of a mobile wireless communications device, and more particularly, a mobile or smartphone. The user device 130 may be in the form of another type of device, for example, a personal computer, tablet computer, laptop computer, or wearable computer.

The influencer scoring system 120 also includes an influencer scoring server 140. The influencer scoring server 140 includes a processor 141 and an associated memory 142. While the influencer scoring system 140 is described herein in terms of operations, the processor 141 and the memory 142 cooperate to perform the operations.

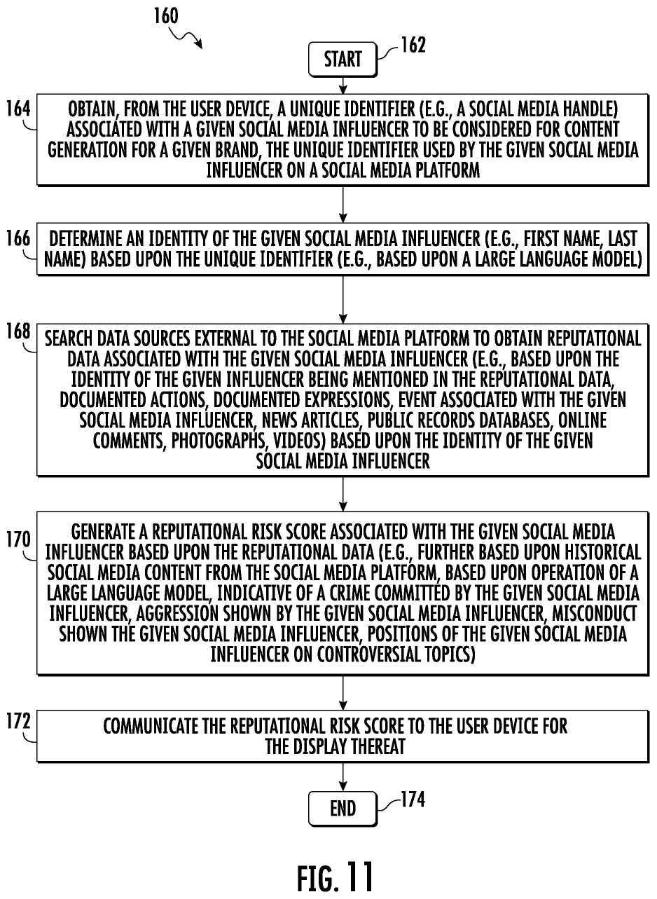

Referring now additionally to the flowchart 160 in FIG. 11, beginning at Block 162, operations of the influencer scoring server 140 will now be described. At Block 164, the influencer scoring server 140 obtains from the user device 130, a unique identifier 121 associated with a given social media influencer 124 to be considered for content generation for a given brand, the unique identifier used by the given social media influencer on a social media platform. A user, for example, associated with the user device 130, may provide the unique identifier 121 as input to the user device. The unique identifier 121 may be in the form of a social media handle, for example. For example, if the given social media influencer 124 is a shopping or brand influencer, the given social media influencer may go by “_janeblogsalot”. Content posted, including likes and comments, by the given social media influencer 124 may be associated with the unique identifier, for this example, “_janeblogsalot.”

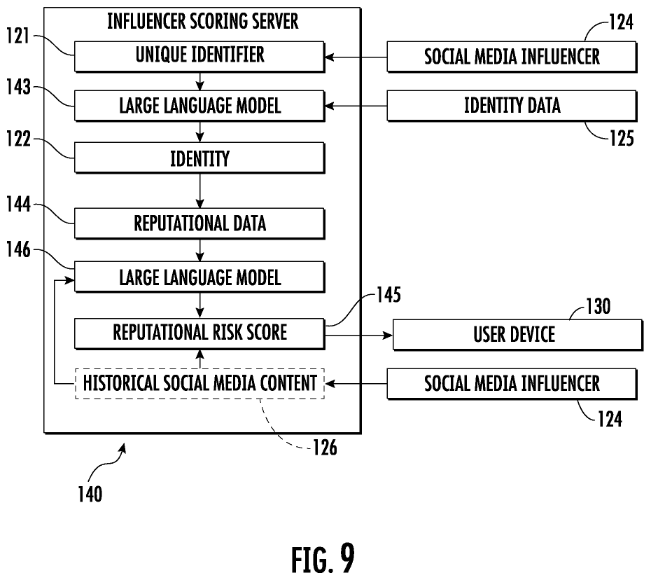

The influencer scoring server 140, at Block 166, determines an identity 122 of the given social media influencer 124 based upon the unique identifier 121. The identity 122 may include a first name and a last name associated with the given social media influencer 124. For example, for the given social media influencer 124, the identity 122 may be “Jane Doe.” The influencer scoring server 140 may determine the identity 122 of the given social media influencer 124 by operating a large language model (LLM) 143 (FIG. 9) based upon the unique identifier 121. The LLM 143 may accept as input thereto the unique identifier 121, and may learn, with each iteration, how different handles resolve to different names.

The LLM 143 operates to learn permutations and standardize “snippets” of data for combination with the social media handle 121. The LLM 143 returns the identity 122. With each iteration of the LLM 143 (e.g., during learning), the LLM increases accuracy and speed, for example, at resolving first and last names (i.e., identity 122) of the social media influencer 124 behind or associated with the social media handle (unique identifier 121) and thus may also reduce computing power for operating the LLM. For example, with each iteration, speed may be improved through drop out (e.g., randomized drop out), which may reduce the size of the model, thus decreasing memory and floating point operational guidelines (e.g., operational requirements) while increasing speed and maintaining accuracy.

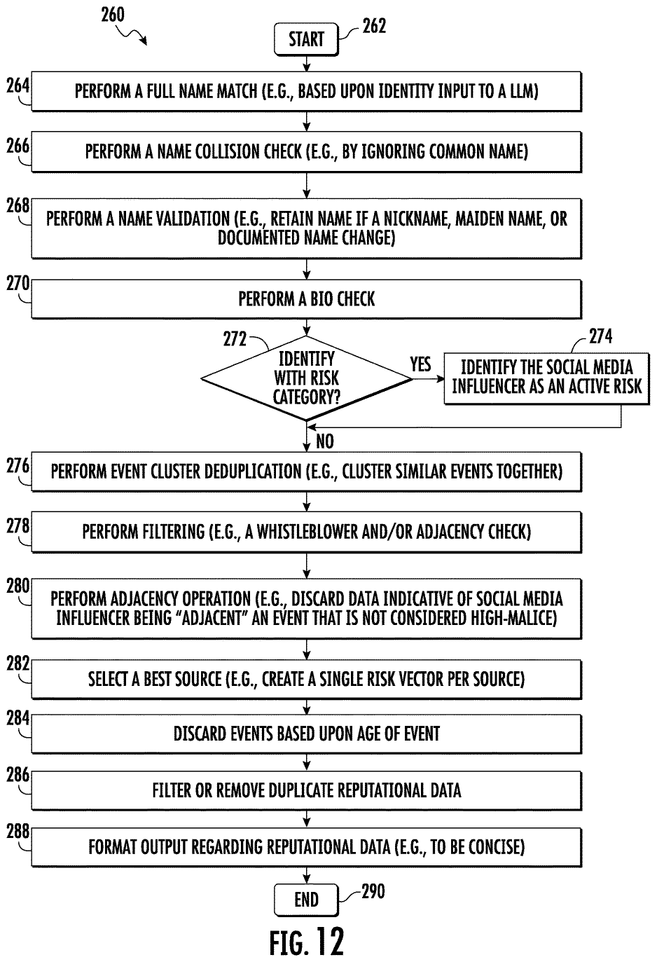

Referring now additionally to the flowchart 260 in FIG. 12, beginning at Block 262, further details of processes for identification and risk event determination will now be described with what may conceptually be considered a risk extraction process. Operations regarding the risk extraction process or identification of the social media influencer 124 may be performed in phases. Phase 0, for example, may perform what may be considered a zero-tolerance identity verification. It may be desirable that these operations are performed before any reputational risk score is generated, as will be described in further detail below. Within phase 0, the influencer scoring server 140 may perform a full name match (Block 264).

The influencer scoring server 140 may obtain identity data 125 (FIG. 9), for example, from the internet, which may include articles, government data, website data, or other data subsets that define evidence to support the determination of the identity 122 from the unique identifier 121. The identity data 125 may be input to the LLM 143 and considered by the influencer scoring server 140 as evidence to support a finding or match between the social media influencer handle 121 and the first and last name 122 of the social media influencer 124.

When performing a full name match, it may be desirable that the identity data 125 or evidence explicitly mention the full name 122 (e.g., “Jane Doe”) of the social media influencer 124 and/or their unique handle 121 (e.g., “_janeblogsalot”). The influencer scoring server 140 may discard partial matches. That is, if the identity data 125 only matches a first name (e.g., just “Jane”) or a last name (e.g., just “Doe”), unless the unique handle 121 is also present in the same document, article, website, etc., as will be appreciated by those skilled in the art.

The influencer scoring server 140 may also, in phase 0, perform a name collision check (Block 266). During name collision check operations, the influencer scoring server 140 may discard or ignore common names. For example, if the determined identity, or target, is “Jane Doe”, the influencer scoring server 140 may ignore “John Doe”, “Clayton Jane”, or “J. Jane”, for example.

The influencer scoring server 140 may also, in phase 0, perform a relatively strict name validation (Block 268). For example, if the first name differs from the target's canonical first name, that data from the identity data 125 may be discarded. An exception to this process flow may be to retain the associated data if (e.g., only if) the mismatch is a verifiable nickname (e.g., Bill/William), maiden name, or documented legal name change.

As will be appreciated by those skilled in the art, the influencer scoring server 140 may perform the above-described identity resolution based upon not only the unique identifier 121, but also based upon other disambiguating data elements, for example, country/location, interests, and associated names or aliases. Of course, other disambiguating data may be used. The influencer scoring server 140 may consider some or all of the disambiguating data elements and weigh the different elements for scoring and relative to a confidence-threshold, for example. In other words, in some embodiments, partial matching relative to a confidence threshold may be the basis for determining the identity of the given social media influencer 124.

In phase 1, the influencer scoring server 140 performs a bio-check (Block 270). The bio-check may not be optional in some embodiments. The influencer scoring server 140 may check biographical data (e.g., on the social media platform) and/or unique identifier 121, both of which may be obtained by the influencer scoring server. If the given social media influencer 124 explicitly identifies with what may be considered a risk category to the brand (Block 272) (e.g., “Shooting Channel”, “Political Analyst”, “Cannabis Reviewer”), the influencer scoring server 140 may define the given social media influencer an “active risk” (Block 274). In an embodiment, the data associated with the bio-check may be considered relatively strong (e.g., firsthand) since it is explicit from the given social media influencer 124. Thus, a verifiable source, for example, from external data sources 150a-150n, may not be desirable as supporting evidence.

In some embodiments, the influencer scoring server 140 may communicate with the user device 130 to cause the user device to display the identity of social media influencer 124, by identity 122 and/or unique identifier 121, along with a notification of the “active” risk, the source data (e.g., outside platform profile bio and/or profile bio on the social media platform), and the date of the biographical data (e.g., retrieval date 154, “current”).

At Block 168 (FIG. 11), the influencer scoring server 140 searches data sources 150a-150n that are external to the social media platform to obtain reputational data 144 associated with the given social media influencer 124. The influencer scoring server 140 may obtain the reputational data 144 based upon the determined identity 122. The reputational data 144 may include news articles, public records databases, online comments, photographs, and/or videos. The reputational data 144 may include follower likes, comments, and/or group membership. The reputational data 144 may include other and/or additional types of data from other and/or additional sources, as will be appreciated by those skilled in the art.

Referring again to the flowchart 260 in FIG. 12, in phase 2 of the risk extraction process, the influencer scoring server 140 may perform event clustering and synthesis. A first step of phase 2 may be considered cluster deduplication (Block 276). The influencer scoring server 140 groups snippets or obtained reputational data 144 that refer to the same real-world incident together. The grouping may occur regardless of data source 150a-150n, date, language, or publisher, for example. For example, “Vice (December, 2022)” and “News.com.au (December, 2022)” discussing ‘U.S. Army Streaming’ may be considered the same event.

In a second step of phase 2, the influencer scoring server 140 may perform filtering (e.g., performing a whistleblower and adjacency check) (Block 278). The influencer scoring server 140 may check the given social media influencer's role in an event based upon the reputational data 144. For example, if the given social media influencer 124 is determined to be a victim, witness, or enforcer/whistleblower (e.g., catching cheaters, exposing a scam), the event or cluster of the reputational data 144 may be discarded from further consideration by the influencer scoring server 140. In other words, if the given social media influencer 124 is not a direct actor in the event based upon the reputational data 144, that reputational data may be discarded from further consideration.

The influencer scoring server 140 may perform a relatively strict adjacency operation-discarding “guilt by association” unless the given social media influencer 124 is cited alongside what may be considered “high-malice” crimes (e.g., murder, gangs, trafficking) (Block 280). If the given social media influencer 124 is merely “adjacent” to what may be considered low level drama (e.g., a copyright dispute they were not involved in), the influencer scoring server 140 may discard that cluster or segment of the reputational data 144 from further consideration. In some embodiments, the brand, via the user device 130, may determine or set what is a high-crime and/or what constitutes “adjacency”, as will be appreciated by those skilled in the art.

During a third step of phase 2, the influencer scoring server 140 may select a best source 150a-150n (Block 282). For the remaining valid clusters of the reputational data 144, the influencer scoring server 140 may create a single risk vector per cluster. The influencer scoring server 140 may select the primary source 150a-150n, for example, the article that broke the news. The influencer scoring server 140 may use the earliest date found in the cluster, thus selecting the date. The influencer scoring server 140 may also discard from further consideration, events or reputational data 144 based upon age of the event or reputational data (Block 284). For example, if the event happened many years ago (e.g., 10 years ago for a DUI), the influencer scoring server 140 may discard that reputational data or event. In some embodiments, the influencer scoring server 140 may weigh an event based upon recency. For example, the longer the time since the event, the less the event may be weighted (e.g., and compared to a threshold). Moreover, the influencer scoring server 140 may also consider and weigh rehabilitating actions, for example, disavowing, correcting, or contextualizing an earlier event, which may also be considered in determining the weight of the previous event and whether the event should be considered.

A third phase (phase 3) of the risk extraction process may apply relatively strict output rules. For example, the influencer scoring server 140 may filter or remove duplicates or duplicate reputational data 144 (as this may penalize the scoring of the given social media influencer 124) of the same event (Block 286). Moreover, the influencer scoring server 140 may filter and remove “recaps”. For example, if an article mentions another article's event as context, the influencer scoring server 140 will not create a new vector.

Phase 4 of the risk extraction process provides constraints on any output. For example, the influencer scoring server 140 may format any output regarding the reputational data 144 (Block 288) to be concise, and evidence may be limited (i.e., every minor incident may not be listed and similar events may be grouped into a single entry). In some embodiments, the influencer scoring server 140 may provide a limit on the number of events or risk vectors (e.g. 8 total) and prioritize what may be considered the most severe. Minor issues, such as, for example, traffic or civil infractions, may be consolidated into a “minor_misconduct” vector. Descriptions and snippets of evidence may be limited to threshold word amount, for example, to under 40 words each. Risk extracting operations end at Block 290.

Referring again to the flowchart 160 in FIG. 11, the influencer scoring server 140 generates a reputational risk score 145 associated with the given social media influencer 124 based upon the reputational data 144 (Block 170). More particularly, the generation of the reputational risk score 145 may be based upon risk categorization and penalty guidelines, which may be based upon the brand, for example.

The influencer scoring server 140 may map the events, snippets, or reputational data 144 any one of enumerated categories 147a, 147b, 147c. In some embodiments, the categories may be limited in number meaning that the reputational data 144 or events must be placed in a given category. If the event does not fit into one of the enumerated categories, it may be determined to not be a reputational risk, and thus, have no effect on the reputational risk score 145.

In a first pillar of generating the reputational risk score 145, the actions or documented actions from the reputational data 144 (e.g., behavior and conduct) are considered. These actions may be considered behavioral acts that generally create liability or real-world harm. For example, a category may include “high malice” and correspond to a highest reduction (e.g., −1) in the reputational risk score 145. “High malice may include violence, fraud, hate crimes, sexual predation, and trafficking, for example. Other action categories may include “major misconduct” (e.g., −0.4 and including legal regulatory failures, driving under the influence, arrests, securities fines, tax evasion), “targeted aggression” 147a (e.g., −0.3 145a and including platform malice, doxxing, brigading, cyberstalking, and revenge porn), and “minor misconduct” (e.g., −0.15 and including administrative failures, copyright strikes, Federal Trade Commission disclosure warnings, civil disputes/lawsuits).

In a second pillar of generating the reputational risk score 145, the expressions or documented expressions from the reputational data 144 (e.g., speech and content) are considered. These expressions may be considered content themes or speech patterns that may create brand alienation, for example. These categories may include “adult” (e.g., −0.3 and including pornography, nudity, sexual gratification/fetish content), “vice regulated” (e.g., −0.3 and including alcohol, gambling/betting, tobacco/vaping, cannabis, illegal drugs, illegal firearm possession/modification (gun crime)), “toxic expression” 147b (e.g., −0.3 145b and including hate speech, slurs, constant feuds/drama, aggressive rhetoric, “adjacency” to crime news), “value polarization” (e.g., −0.2 and including suitability risks, politics, social justice, religion or anti-religion, sensitive health (abortion/vaccines), legal guns/firearms (enthusiast content; gun culture)), and “deplatforming” 147c (e.g., −0.15 145c and including volatility flagging, past/indefinite bans, and temporary suspensions).

In some embodiments, the influencer scoring server 140 may optionally generate the reputational risk score 145 further based upon historical social media content 126 from the social media platform (FIG. 9). More particularly, the influencer scoring server 140 may scrape content generated by the social media influencer 124 or associated with the social media influencer (e.g., liked, group membership, comments, etc.) and store this content as the historical social media content 126. The influencer scoring server 140 may generate (e.g. adjust) the reputational risk score 145 based upon this historical social media content 126, and, for example, in accordance with the scoring rubric described herein.

In an embodiment, the influencer scoring server 140 may generate the reputational risk score 145 based upon operation of a large language model (LLM) 146 (FIG. 9). For example, the LLM 146 may accept as input thereto all the actions, expressions, behaviors, and dates, for example, as described above, so that each score allows retraining, restructuring, and defending of any particular reputational risk score 145. The LLM 146 may advantageously turn news into structured, comparable, explainable risk cases that are scored and anchored to historical judgments. Those skilled in the art will appreciate that the functions of the LLM 146 may be relatively hard to achieve with rules or a single supervised classifier, for example. Moreover, similar to the LLM 143 described above, with each iteration, the LLM 146 may become more accurate in its determination or increase speed with each iteration, thus reducing computing power for operating the LLM.

At Block 172, the influencer scoring server 140 communicates the reputational risk score 145 to the user device 130 for display thereat. More particularly, the influencer scoring server 140 may communicate with the user device 130 so that the user device displays the source 150a-150n of the reputational data 144 used to generate the reputational risk score 145. For example, if the reputational data 144 or snippet serving as a basis for the reputational risk score is found in search snippets, the uniform resource locator (URL) (e.g., https:// . . . ) may be displayed, if the snippet was found in the profile or bio of the social media influencer 124, the string “Profile Bio” 150b may be displayed, and if the snippet was found in another source, the source name 150c (e.g., with a link or document attachment). The corresponding reputational data 144 (i.e. evidence_snippet) may be displayed alongside the source, for example, and may include a direct quote or concise summary from the source text verifying the event along with the event date.

The influencer scoring server 140 may communicate the reputational risk score 145 along with the above-described information to the user device 130 as a structured JSON object that may satisfy an application programming interface (API) schema, as will be appreciated by those skilled in the art. The reputational risk score 145 may be displayed as a suggested penalty, for example, based upon the negative float values from the category guidelines described above (e.g., −0.15). Of course, the reputational risk score 145 may be another type of score, for example, a composite numerical score (e.g. 75 out of 100), a letter score (e.g., A), a relative score (e.g., −2.0). Operations end at Block 174.

As will be appreciated by those skilled in the art, the influencer scoring system 120 may be particularly advantageous for identifying a potential risk to a brand from public positions taken a given social media influencer, for example, being considered by the brand for content creation or for advocating for the brand. The present embodiments may be used with the above-described embodiments, for example, as described with respect to FIG. 7. The present reputational risk score may be used as a basis to generate the influencer fit score or in the alternative, as an independent score considered used as a basis for the total fit score.

Moreover, those skilled in the art will appreciate that it may be desirable (e.g., responsible use of AI) to provide the reputational risk score 145 alongside or with the corresponding source that supports the reputational risk score (i.e., data source 150a-150n). By providing the source supporting the reputational risk score 145, the source can be checked for accuracy and/or for disambiguation. Thus, incorrectly identified data may be corrected, and further accountability and transparency may be provided.

A method aspect is directed to a method of scoring an influencer. The method includes using an influencer scoring server 140 to obtain, from a user device 130, a unique identifier 121 associated with a given social media influencer 124 to be considered for content generation for a given brand. The unique identifier 121 is used by the given social media influencer 124 on a social media platform. The method includes using the influencer scoring server 140 to determine an identity 122 of the given social media influencer 124 based upon the unique identifier 121 and search a plurality of data sources 150a-150n external to the social media platform to obtain reputational data 144 associated with the given social media influencer based upon the identity of the given social media influencer. The method also includes using the influencer scoring server 140 to generate a reputational risk score 145 associated with the given social media influencer 124 based upon the reputational data 144 and communicate the reputational risk score 145 to the user device 130 for display thereat.

A computer readable medium aspect is directed to a non-transitory computer readable medium for scoring an influencer. The non-transitory computer readable medium includes computer executable instructions that when executed by a processor 141 cause the processor to perform operations. The operations include obtaining, from a user device 130, a unique identifier 121 associated with a given social media influencer 124 to be considered for content generation for a given brand. The unique identifier 121 is used by the given social media influencer 124 on a social media platform. The operations include determining an identity 122 of the given social media influencer 124 based upon the unique identifier 121 and searching a plurality of data sources 150a-150n external to the social media platform to obtain reputational data 144 associated with the given social media influencer based upon the identity of the given social media influencer. The operations also include generating a reputational risk score 145 associated with the given social media influencer 124 based upon the reputational data 144 and communicating the reputational risk score to the user device 130 for display thereat.

While several embodiments have been described herein, it should be appreciated by those skilled in the art that any element or elements from one or more embodiments may be used with any other element or elements from any other embodiment or embodiments. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. An influencer scoring system comprising:
a user device; and
an influencer scoring server configured to
obtain, from the user device, a unique identifier associated with a given social media influencer to be considered for content generation for a given brand, the unique identifier used by the given social media influencer on a social media platform,
determine an identity of the given social media influencer based upon the unique identifier,
search a plurality of data sources external to the social media platform to obtain reputational data associated with the given social media influencer based upon the identity of the given social media influencer,
generate a reputational risk score associated with the given social media influencer based upon the reputational data, and
communicate the reputational risk score to the user device for display thereat.

2. The influencer scoring system of claim 1 wherein the influencer scoring server is configured to obtain the reputational data based upon the identity of the given social media influencer being mentioned in the reputational data.

3. The influencer scoring system of claim 1 wherein the reputational data comprises at least one of documented actions and documented expressions of the given social media influencer.

4. The influencer scoring system of claim 1 wherein the influencer scoring server is configured to discard duplicate reputational data.

5. The influencer scoring system of claim 1 wherein the reputational data comprises at least one event associated with the given social media influencer, and wherein the influencer scoring server is configured to determine whether the given social media influencer is a direct actor of the at least one event, and if not, discard the reputational data associated with the at least one event.

6. The influencer scoring system of claim 1 wherein the identity comprises a first name and a last name associated with the given social media influencer.

7. The influencer scoring system of claim 1 wherein the influencer scoring server is configured to generate the reputational risk score further based upon historical social media content from the social media platform.

8. The influencer scoring system of claim 1 wherein the influencer scoring server is configured to discard reputational data based upon an age of the reputational data.

9. The influencer scoring system of claim 1 wherein the influencer scoring server is configured to operate a large language model (LLM) to generate the reputational risk score.

10. The influencer scoring system of claim 1 wherein the influencer scoring server is configured to operate a large language model (LLM) to determine the identity of the given social media influencer based upon the unique identifier.

11. The influencer scoring system of claim 1 wherein the influencer scoring server is configured to generate the reputational risk score for reputational data indicative of at least one of a crime committed by the given social media influencer, aggression shown by the given social media influencer, misconduct shown by the given social media influencer, and positions of the given social media influencer on controversial topics.

12. The influencer scoring system of claim 1 wherein the reputational data comprises news articles, public records databases, online comments, photographs, and videos.

13. An influencer scoring server comprising:
a processor and an associated memory configured to
obtain, from a user device, a unique identifier associated with a given social media influencer to be considered for content generation for a given brand, the unique identifier used by the given social media influencer on a social media platform,
determine an identity of the given social media influencer based upon the unique identifier,
search a plurality of data sources external to the social media platform to obtain reputational data associated with the given social media influencer based upon the identity of the given social media influencer,
generate a reputational risk score associated with the social media influencer based upon the reputational data, and
communicate the reputational risk score to the user device for display thereat.

14. The influencer scoring server of claim 13 wherein the processor is configured to obtain the reputational data based upon the identity of the given social media influencer being mentioned in the reputational data.

15. The influencer scoring server of claim 13 wherein the processor is configured to discard duplicate reputational data.

16. The influencer scoring server of claim 13 wherein the processor is configured to generate the reputational risk score further based upon historical social media content from the social media platform.

17. The influencer scoring server of claim 13 wherein the processor is configured to discard reputational data based upon an age of the reputational data.

18. The influencer scoring server of claim 13 wherein the influencer scoring server is configured to operate a large language model (LLM) to generate the reputational risk score.

19. The influencer scoring server of claim 13 wherein the processor is configured to operate a large language model (LLM) to determine the identity of the given social media influencer based upon the unique identifier.

20. A method of scoring an influencer comprising:
using an influencer scoring server to
obtain, from a user device, a unique identifier associated with a given social media influencer to be considered for content generation for a given brand, the unique identifier used by the given social media influencer on a social media platform,
determine an identity of the given social media influencer based upon the unique identifier,
search a plurality of data sources external to the social media platform to obtain reputational data associated with the given social media influencer based upon the identity of the given social media influencer,
generate a reputational risk score associated with the social media influencer based upon the reputational data, and
communicate the reputational risk score to the user device for display thereat.

21. The method of claim 20 wherein using the influencer scoring server comprises using the influencer scoring server to obtain the reputational data based upon the identity of the given social media influencer being mentioned in the reputational data.

22. The method of claim 20 wherein using the influencer scoring server comprises using the influencer scoring server to obtain the reputational data based upon the identity of the given social media influencer being mentioned in the reputational data.

23. The method of claim 20 wherein using the influencer scoring server comprises using the influencer scoring server to generate the reputational risk score further based upon historical social media content from the social media platform.

24. The method of claim 20 wherein using the influencer scoring server comprises using the influencer scoring server to operate a large language model (LLM) to generate the reputational risk score.

25. The method of claim 20 wherein using the influencer scoring server comprises using the influencer scoring server to operate a large language model (LLM) to determine the identity of the given social media influencer based upon the unique identifier.

26. A non-transitory computer readable medium for scoring an influencer, the non-transitory computer readable medium comprising computer executable instructions that when executed by a processor cause the processor to perform operations comprising:
obtaining, from a user device, a unique identifier associated with a given social media influencer to be considered for content generation for a given brand, the unique identifier used by the given social media influencer on a social media platform;
determining an identity of the given social media influencer based upon the unique identifier;
searching a plurality of data sources external to the social media platform to obtain reputational data associated with the given social media influencer based upon the identity of the given social media influencer;
generating a reputational risk score associated with the social media influencer based upon the reputational data; and communicating the reputational risk score to the user device for display thereat.

27. The non-transitory computer readable medium of Claim 26 wherein the operations comprise obtaining the reputational data based upon the identity of the given social media influencer being mentioned in the reputational data.

28. The non-transitory computer readable medium of Claim 26 wherein the operations comprise generating the reputational risk score further based upon historical social media content from the social media platform.

29. The non-transitory computer readable medium of Claim 26 wherein the operations comprise operating a large language model (LLM) to generate the reputational risk score.

30. The non-transitory computer readable medium of Claim 26 wherein the operations comprise operating a large language model (LLM) to determine the identity of the given social media influencer based upon the unique identifier.
